(19) United States
(12) Patent Application Publication
(10) Pub. No.: US 2015/0156357 A1
(43) Pub. Date: Jun. 4, 2015

(54) DOCUMENT READING APPARATUS, DOCUMENT READING APPARATUS CONTROL METHOD, AND STORAGE MEDIUM

(71) Applicant: CANON KABUSHIKI KAISHA, Tokyo (JP)

(72) Inventor: Keita Yabe, Yamato-shi (JP)

(21) Appl. No.: 14/553,414

(22) Filed: Nov. 25, 2014

(30) Foreign Application Priority Data
Nov. 29, 2013 (JP) 2013-248037

(51) Int. Cl. H04N 1/00; H04N 1/047

(52) U.S. Cl. CPC H04N 1/00803; H04N 1/047; H04N 1/00824; H04N 1/00925

(57) ABSTRACT

A document reading apparatus sets whether to stop a reading operation of a document based on detection of a double feed.

### BACKGROUND OF THE INVENTION

1. Field of the Invention

The present invention relates to a document reading apparatus, a document reading apparatus control method, and a storage medium.

2. Description of the Related Art

Conventionally, a document reading apparatus reads a document placed on a document positioning plate, or a document conveyed by an automatic document conveyance apparatus (ADF), and generates image data representing an image of the read document.

In such a document reading apparatus, when reading the document, the document may be conveyed in a state in which a plurality of pages of the document overlap each other. Such a situation in which the two or more pages of the document are conveyed overlapping each other is called a double feed. If the pages of the document are double fed, a document image cannot be correctly read, so that some pages may be left out of the generated image data.

Accordingly, Japanese Patent Application Laid-Open No. 2008-271537 discusses a technology that detects a document double feed with a sensor, temporarily stops reading of the document if the document double feed is detected, and displays a screen on an operation unit that lets a user select whether to continue document reading.

However, in the conventional art, since a document double feed is detected regardless of the type of document and document reading stops when a double feed has been detected, document reading stops even if the document is being properly conveyed.

For example, an envelope is a document in which two sheets overlap each other. If the document is an envelope, even if the envelope is being properly conveyed, document reading stops. Further, even for a document on which a photograph or a label has been pasted, even if the document is being properly conveyed, document reading stops, since two or more sheets overlap each other.

When document reading stops, document reading does not start again unless the user issues an instruction to continue document reading each time. Consequently, the user cannot move away from in front of the reading apparatus until document reading is completed.

### SUMMARY OF THE INVENTION

According to an aspect of the present invention, a document reading apparatus includes a conveyance unit configured to convey a document, a detection unit configured to detect a double feed of the document conveyed by the conveyance unit, a reading unit configured to read an image of the document conveyed by the conveyance unit, a setting unit configured to set whether to stop a reading operation of the document as a setting of the document reading apparatus based on detection of a double feed of the document by the detection unit, and a control unit configured to, if the reading operation of the document has been set by the setting unit to stop based on detection of a double feed of the document by the detection unit, control so as to stop the reading operation of the document based on detection of a double feed of the document by the detection unit, and if the reading operation of the document has been set by the setting unit not to stop based on detection of a double feed of the document by the detection unit, control so as to continue without stopping the reading operation of the document based on detection of a double feed of the document by the detection unit.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image processing apparatus according to an exemplary embodiment.

FIG. 2 is a cross-sectional view illustrating a configuration of an image processing apparatus according to an exemplary embodiment.

FIG. 3 illustrates a screen according to an exemplary embodiment.

FIG. 4 is a flowchart illustrating a control example according to an exemplary embodiment.

FIG. 5 is a flowchart illustrating a control example according to an exemplary embodiment.

FIG. 6 illustrates a screen according to an exemplary embodiment.

FIG. 7 illustrates a screen according to an exemplary embodiment.

FIG. 8 is a flowchart illustrating a control example according to an exemplary embodiment.

FIG. 9 is a flowchart illustrating a control example according to an exemplary embodiment.

### DESCRIPTION OF THE EMBODIMENTS

Various exemplary embodiments, features, and aspects of the invention will be described in detail below with reference to the drawings. The following exemplary embodiments are not limited to the subject matter described in the scope of claims. Not all of the combinations of the characteristics described in the exemplary embodiments are essential to resolve the problems which the present invention is directed to solving.

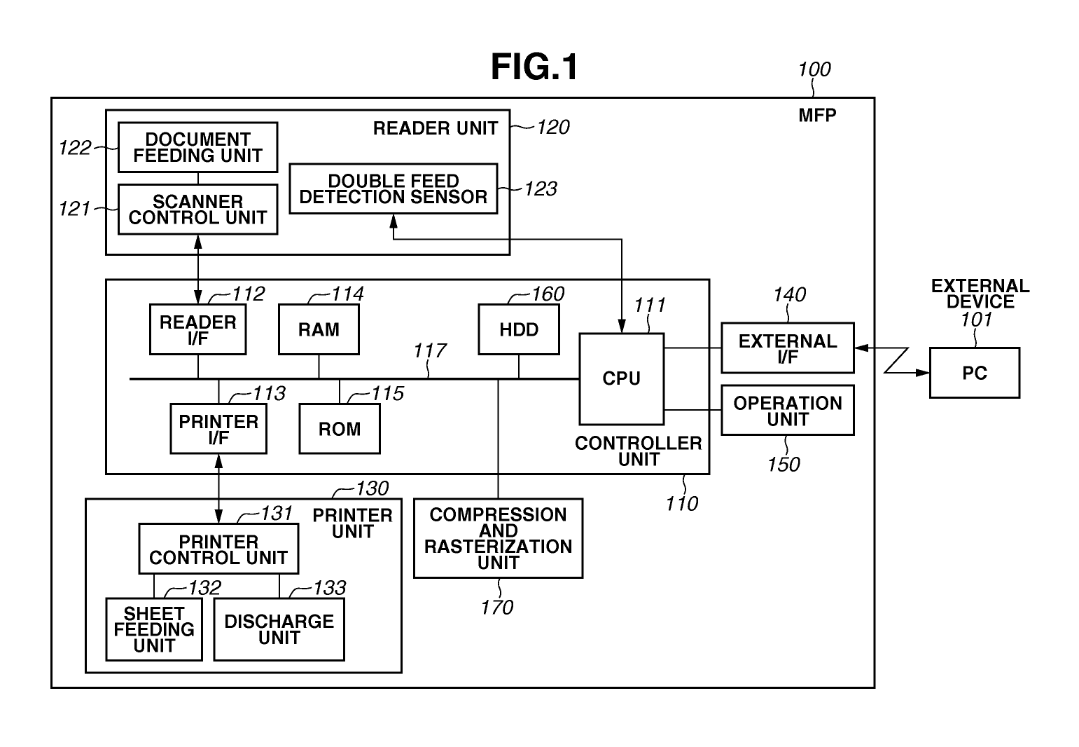

A printing system according to a first exemplary embodiment of the present invention will be described with reference to FIG. 1. The printing system according to the present exemplary embodiment is configured from a multifunction peripheral (MFP) 100 that includes a function as a document reading apparatus configured to read an image of a document, and a personal computer (PC) 101 that is an external information processing apparatus. The MFP 100 may include, in addition to an image reading apparatus, a function as a printing apparatus (also called an image forming apparatus) that prints read image data on a sheet.

The MFP 100 is connected to and communicates with the PC 101 via a local area network (LAN), for example, or a wide area network (WAN) such as the Internet. Further, although the present exemplary embodiment is described using an example in which the MFP 100 and the PC 101 are connected via a wired LAN, the MFP 100 and the PC 101 may also be connected via a universal serial bus (USB) cable. In addition, the MFP 100 and the PC 101 may also be communicably configured by wireless communication, such as by wireless fidelity (Wi-Fi) or Bluetooth®. The MFP 100 may be any MFP, as long as it can print in color or monochrome.

The PC 101 generates image data with application software, and transmits the generated image data to the MFP 100. Although the present exemplary embodiment is described using the PC 101 as an example of an external information processing apparatus, the present invention is not limited to the PC 101. The external information processing apparatus may be a mobile information terminal such as a personal digital assistant (PDA) or a smartphone.

The MFP 100 according to the present exemplary embodiment includes a below-described controller unit (control unit) 110, a reader unit 120, a printer unit 130, an external I/F 140, an operation unit 150, a hard disk drive (HDD) 160, and a compression and rasterization unit 170. These units are electrically connected, and send and receive control commands and data to each other. Further, although the present exemplary embodiment is described using the MFP 100 as an example of a printing apparatus, the printing apparatus may be a single function peripheral (SFP), as long as it has a printing function.

The reader unit 120 includes a scanner control unit 121 that controls communication with the controller unit 110, a document feeding unit 122 (also referred to as a DF unit or an ADF unit) that feeds the document, and a double feed detection sensor 123 that detects a double feed of conveyed document pages. The double feed detection sensor 123 may be, for example, a sensor that utilizes ultrasonic waves, an optical sensor and the like. Further, an instruction to read a document with the reader unit 120 is issued from the controller unit 110 via the scanner control unit 121. The reader unit 120 optically reads an image of the document based on the document reading instruction, and converts the read image into image data as an electric signal. Although the present exemplary embodiment is described below for a case in which an instruction to read a document with the reader unit 120 is issued via the scanner control unit 121 from the controller unit 110, the present invention is not limited to this. If the MFP does not have a scanner control unit 121 in the reader unit 120, the document reading instruction can also be directly issued from a central processing unit (CPU) 111 of the controller unit 110.

The printer unit 130 includes a printer control unit 131 that controls communication with the controller unit 110. In addition, the printer unit 130 includes a sheet feeding unit 132 that includes a plurality of sheet storage units (sheet feed stages) that store sheets to be used in printing, and a discharge unit 133 that performs staple processing and shift processing on the print product. Further, the printer unit 130 executes print processing on a printing target job that is stored in the HDD 160 of the controller unit 110. An instruction to print image data with the printer unit 130 is issued from the controller unit 110 via the printer control unit 131. The image data is transferred and fixed by forming (printing) an image based on the image data using toner on a sheet fed from a sheet feed stage. Although the present exemplary embodiment is described below for a case in which an instruction to print image data with the printer unit 130 is issued from the controller unit 110 via the printer control unit 131, the present invention is not limited to this. If the MFP does not have a printer control unit 131 in the printer unit 130, the image data printing instruction can also be directly issued from the CPU 111 of the controller unit 110.

The controller unit 110 includes therein a non-volatile memory, such as the HDD 160, capable of storing a plurality of processing target jobs. Although the present exemplary embodiment is described using the HDD 160 as an example of a large-capacity, non-volatile storage device, other non-volatile memories, such as a digital versatile disc (DVD), a Blu-Ray Disc, and a solid-state drive (SSD), can also be used.

Further, the controller unit 110 includes the CPU 111, a random-access memory (RAM) 114, a read-only memory (ROM) 115, a reader I/F 112, and a printer I/F 113.

The CPU 111 controls processing or an operation of each unit included in the MFP 100. The ROM 115 is a dedicated memory for reading, in which programs such as a boot sequence and font information are pre-stored. On the other hand, the RAM 114 is a memory capable of reading and writing, which stores image data transmitted from the reader unit 120 or the external I/F 140, various programs, and setting information.

Various control programs for executing each process in the below-described flowcharts that are executed by the CPU 111 are stored in the ROM 115 or the HDD 160. Further, a display control program that displays various user interface (UI) screens on a display unit of a below-described operation unit 150 for receiving operations from a user via the screens are also stored in the ROM 115.

The compression and rasterization unit 170 performs processing for compressing and decompressing image data, for example, stored in the RAM 114 and the HDD 160 based on various compression methods, such as Joint Bi-level Image Experts Group (JBIG) and Joint Photographic Experts Group (JPEG), and re-stores the processed image data in the RAM 114. The image data compressed by the compression and rasterization unit 170 can be transmitted to an external device via the external I/F 140.

The reader I/F 112 is an interface for connecting to the reader unit 120, which is an image reading apparatus. The printer I/F 113 is an interface for connecting to the printer unit 130, which is an image output apparatus.

Further, the MFP 100 includes the operation unit 150 that has a display unit.

The operation unit 150 in the MFP 100 according to the present exemplary embodiment includes a not-illustrated display unit and hard keys. The display unit is configured from a liquid crystal display (LCD) unit and a touch panel sheet formed from a transparent electrode (which may be a capacitance type) stuck on the LCD. An operation screen and a state of the MFP 100 are displayed on the LCD. The operation unit 150 includes a function of receiving various settings from the user via the operation screen or the hard keys and a function of providing information to the user.

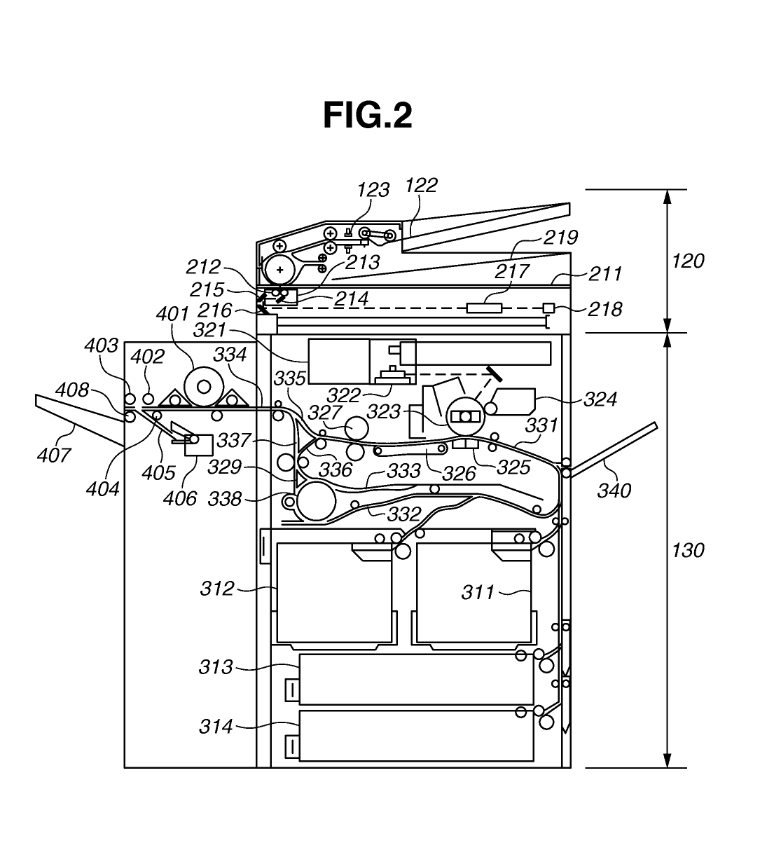

Now, a cross-sectional view of the reader unit 120 and the printer unit 130 illustrated in FIG. 1 will be described with reference to FIG. 2.

The document feeding unit 122 in the reader unit 120 feeds the pages of a document set on a document positioning plate one by one. The conveyed document pages pass by the double feed detection sensor 123, and reach an optical unit 213. The document pages that have been conveyed to the optical unit 213 are then discharged onto a discharge tray 219.

The double feed detection sensor 123 detects that a double feed has occurred for a document when the document pages fed from the document feeding unit 122 are conveyed. For example, a double feed is detected by the double feed detection sensor 123 utilizing ultrasonic waves by emitting ultrasonic waves from an upper sensor and sensing changes in those ultrasonic waves with a lower sensor. Further, based on a reception intensity when one page of the document is conveyed as a reference, a double feed is determined to have occurred if the reception intensity of an actually detected signal is lower than this reference value. The term “double feed” refers to conveyance of the document in a state in which at least a part of two or more document pages overlap when the document pages fed from the document feeding unit 122 are conveyed. Although the present exemplary embodiment is described using a sensor that utilizes ultrasonic waves as an example of the double feed detection sensor 123, an optical sensor can also be used, as long as it is capable of detecting a double feed. Alternatively, a double feed of the document can also be determined based on measurement data obtained by measuring the thickness of the document pages.

When a document page is conveyed to above the optical unit 213, the reader unit 120 turns on a lamp 212, and irradiates light onto the document page with the optical unit 213. At this stage, reflected light from the document page is guided to a charge-coupled device image sensor (hereinafter “CCD”) 218 by mirrors 214, 215, and 216, and a lens 217. An image of the document page is read by the CCD 218. The image data output from the CCD 218 is subjected to predetermined processing, and then transferred to the controller unit 110.

The reader unit 120 reads an image of the document page placed between the document feeding unit 122 and a platen glass 211. At that point, the reader unit 120 turns on the lamp 212, and moves the optical unit 213. The reflected light from the document page at this stage is guided to the CCD 218 by mirrors 214, 215, and 216, and a lens 217. An image of the document page is read by the CCD 218. The image data output from the CCD 218 is subjected to predetermined processing, and then transferred to the controller unit 110. Although a case has been described here in which the sensor unit that collects the reflected light is a CCD sensor, the present invention is not limited to this. The sensor unit may be a contact image sensor (CIS). If a CIS is used as the sensor unit, the mirrors and lens are not required.

In the printer unit 130, a laser driver 321 drives a laser emitting unit 322. The laser driver 321 makes the laser emitting unit 322 emit laser light based on the image data output from the controller unit 110. The laser light is irradiated on a photosensitive drum 323, and a latent image based on the laser light is formed on the photosensitive drum 323. A developer is adhered by a developing unit 324 on the latent image portion of this photosensitive drum 323.

Further, the printer unit 130 includes, as the sheet feeding unit 132, draw-shaped cassettes 311 to 314 and a manual feeding tray 340. The cassettes 311 to 314 and the manual feeding tray 340 can hold a plurality of sheets. The printer unit 130 feeds a sheet from any one of the cassettes 311 to 314 and manual feeding tray 340, and conveys the fed sheet along a conveyance path 331 to a transfer unit 325. The transfer unit 325 transfers the developer adhered to the photosensitive drum 323 onto the sheet.

The sheet on which the developer has been transferred is conveyed to a fixing unit 327 by a conveyance belt 326. The fixing unit 327 fixes the developer to the sheet with heat and pressure. Then, the sheet, which has passed through the fixing unit 327, passes along a conveyance path 335 and a conveyance path 334, and is discharged. In the case of discharging after inverting a printing face of the sheet, the sheet is guided to a conveyance path 338 via a conveyance path 336. Then, the sheet can be conveyed in the reverse direction, and conveyed along a conveyance path 337 and the conveyance path 334.

Further, if two-sided printing is set, after passing through the fixing unit 327, the sheet passes along the conveyance path 336, and is guided to a conveyance path 333 by a flapper 329. Then, the sheet is conveyed in the reverse direction, guided to the conveyance path 338 by the flapper 329, and then guided to a re-feeding conveyance path 332. The sheet fed to the re-feeding conveyance path 332 passes along the conveyance path 331 at the above-described timing, is conveyed to the transfer unit 325, and developer is transferred onto a second side of the sheet by the transfer unit 325. Then, the sheet passes through the fixing unit 327, and is guided to the conveyance path 334.

Regardless of whether the process is one-sided printing or two-sided printing, a sheet that has been conveyed by passing through the conveyance path 334 is conveyed to the discharge unit 133.

The sheet that has been conveyed to the discharge unit 133 is first sent to a buffer unit 401 of the discharge unit 133. In some cases, the conveyed sheet may be buffered by wrapping around a buffer roller. For example, if a downstream process, such as stapling, is taking time, using this buffering unit 401 allows the conveyance interval of the sheets conveyed from a main unit to be adjusted.

Subsequently, the sheet passes along a conveyance path 404 by a pair of upstream discharge rollers 402 and a pair of downstream discharge rollers 403, and is stacked on a stack tray 405. After a bundle's worth of sheets has been stacked on the stack tray 405, the stacked sheet bundle is passed along a conveyance path 408 and discharged onto a discharge tray 407.

If shifting has been specified, the bundle of sheets stacked on the stack tray 405 is shifted with respect to the sheet bundle that was discharged immediately before that bundle. A break between the bundles formed by discharging sheets onto the discharge tray 407 in this manner makes it easier for the user to see each bundle.

If stapling has been specified, the sheets are conveyed by the pair of upstream discharge rollers 402, passed along the conveyance path 404 by the pair of downstream discharge rollers 403, and stacked on the stack tray 405. Then, staple processing is performed by a staple unit 406 on the sheet bundle stacked on the stack tray 405. The stapled sheet bundle is discharged onto the discharge tray 407 by the pair of downstream discharge rollers 403.

Although the present exemplary embodiment has been described using a monochrome apparatus that includes one developing unit 324 and one photosensitive drum 323, the present invention may also be applied in a color apparatus that includes four developing units and four photosensitive drums for cyan, yellow, magenta, and black, respectively. Further, although in the present exemplary embodiment a method has been described in which an image is printed on a sheet based on an electrophotographic method, an inkjet method can also be used. In addition, other methods can be used, as long as such methods are capable of printing an image.

The MFP 100 having the above configuration can execute a plurality of job types.

For example, the MFP 100 may execute a copy job by reading an image of a document page with the reader unit 120, generating image data representing the image of the read document page, and printing an image on a sheet based on the generated image data and a setting received via the operation unit 150.

Further, the MFP 100 may execute a scan and store job by reading an image of a document page with the reader unit 120, generating image data representing the image of the read document page, and storing the generated image data in the HDD 160.

In addition, the MFP 100 may execute a print job by analyzing print data received from the PC 101, generating image data based on a print setting received from the PC 101, and printing an image on a sheet based on the generated image data.

Still further, the MFP 100 may execute a scan and send job by reading an image of a document page with the reader unit 120, generating image data representing the image of the read document page, and sending the generated image data to the PC 101.

Moreover, the MFP 100 may execute a facsimile transmission job by reading an image of a document page with the reader unit 120, generating image data representing the image of the read document page, and transmitting the generated image data to an external facsimile apparatus via a not-illustrated telephone line.

The MFP 100 receives a plurality of these jobs, stores them in the non-volatile memory 160, and executes the jobs in the order that they were stored in the non-volatile memory 160.

Although a case has been described here in which the MFP 100 executes a plurality of job types, the present invention is not limited to this. The MFP 100 may be configured so that it executes a part of the above-described plurality of job types.

In addition to a plain paper document, the MFP 100 including the above-described functions can convey and read other document types, such as an envelope. For example, there may be a task in which envelopes are periodically sent to the same address. To create the envelope used in such a task, the user writes the address on one envelope, and copies the envelope having that address onto a plurality of envelopes which should have the same address. Further, there may also be a task in which envelopes are periodically sent to a plurality of addresses. In this case, the user may wish to write each of the different addresses on a plurality of envelopes, collectively set these envelopes in the document feeding unit 122, and output the plurality of envelopes on which these addresses are written. Since an envelope is a document in which two sheets overlap each other, if the document is an envelope, when a double feed detection function is set to valid, reading stops each time an envelope is conveyed. Further, even for a document on which a photograph or a label has been pasted, since two or more sheets overlap each other, document reading stops even if the document is properly conveyed. If document reading stops, document reading does not start again unless the user issues an instruction to continue document reading via the screen each time. Consequently, the user cannot move away from in front of the reading apparatus until document reading is completed.

Accordingly, when a document type such as an envelope or a document on which a photograph or a label has been pasted is conveyed, to prevent document reading from stopping, the user sets the double feed detection function to invalid for cases in which a document such as an envelope is to be read. On the other hand, when conveying a plain paper document, the user sets the double feed detection function to valid. Consequently, document reading stops if two or more sheets of plain paper overlap each other, so that the user can be made to reset the document in the ADF.

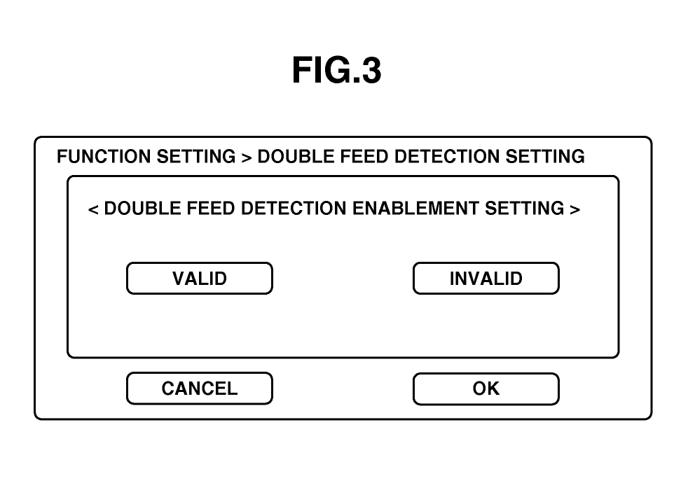

FIG. 3 illustrates an example of a screen displayed on the display unit of the operation unit 150 for setting the document double feed detection function to valid or invalid. Before starting document reading, the user sets in advance the document double feed detection function to valid or invalid via the screen illustrated in FIG. 3. The set content is stored in the HDD 160 by the CPU 111.

If the document double feed detection function has been set by the user to valid, the MFP 100 detects a document double feed, stops document reading based on the fact that a document double feed was detected, and makes the user reset the document in the ADF. On the other hand, if the document double feed detection function has been set by the user to invalid, the MFP 100 controls so that the document double feed detection function by the double feed detection sensor 123 is invalid. An example of a method for setting the document double feed detection function by the double feed detection sensor 123 to invalid is to control so that detection of a double feed by the double feed detection sensor 123 is not performed. For example, the power supply to the double feed detection sensor 123 can be cut. Another example of the method for setting the document double feed detection function by the double feed detection sensor 123 to invalid is to control so that although a signal indicating that a document double feed has been detected by the double feed detection sensor 123 is received, document reading does not stop even if such a signal is received.

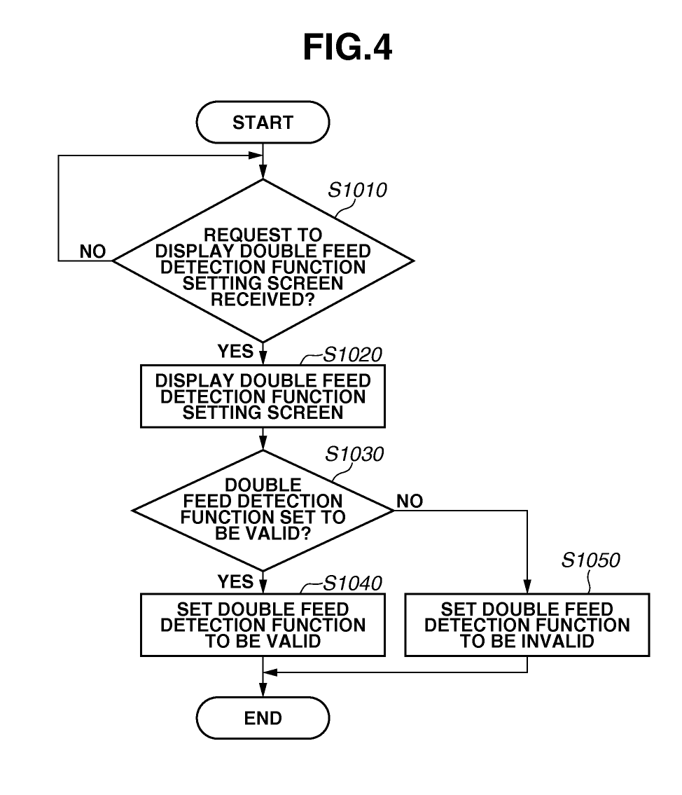

The control for setting the document double feed detection function to valid or invalid will now be described with reference to a flowchart illustrated in FIG. 4. Processing illustrated in the flowchart of FIG. 4 is performed by the CPU 111 reading and executing in the RAM 114 a program stored in the ROM 115. Further, the processing illustrated in this flowchart is set as a MFP 100 device setting before execution of the job.

In step S1010 of FIG. 4, the CPU 111 determines whether a request to display a double feed detection function setting screen has been received via a user mode function setting screen via the operation unit 150. If it is determined that a request to display a double feed detection function setting screen has been received (YES in step S1010), the processing proceeds to step S1020.

In step S1020, the CPU 111 displays the screen illustrated in FIG. 3 on the operation unit 150.

In step S1030, the CPU 111 determines whether the double feed detection function has been set to valid on the screen illustrated in FIG. 3. If “valid” on the screen illustrated in FIG. 3 was selected and an OK key pressed, the CPU 111 determines that double feed detection function has been set to valid (YES in step S1030), and the processing proceeds to step S1040. On the other hand, if “invalid” on the screen illustrated in FIG. 3 was selected and the OK key pressed, the CPU 111 determines that double feed detection function has been set to invalid (NO in step S1030), and the processing proceeds to step S1050.

In step S1040, the CPU 111 stores information in the HDD 160 indicating that the double feed detection function has been set to valid, and ends the processing.

In step S1050, the CPU 111 stores information in the HDD 160 indicating that the double feed detection function has been set to invalid, and ends the processing.

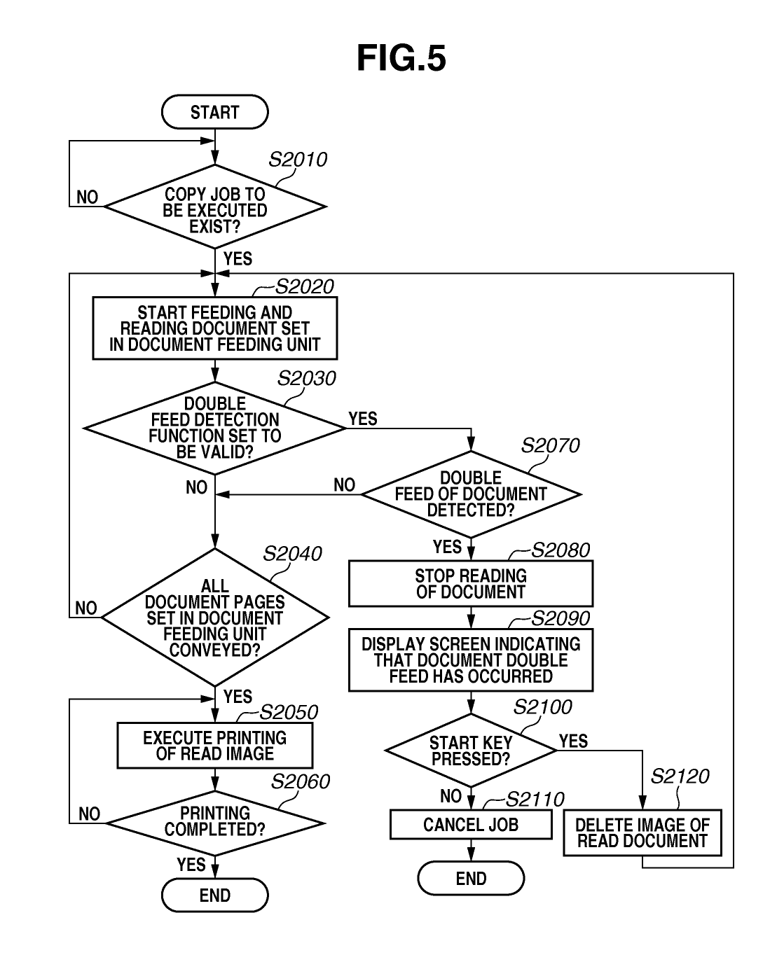

The controls performed by the CPU 111 according to the present exemplary embodiment will now be described with reference to a flowchart illustrated in FIG. 5. Processing illustrated in the flowchart of FIG. 5 is performed by the CPU 111 reading and executing in the RAM 114 a program stored in the ROM 115. This flowchart illustrated in FIG. 5 is executed after the double feed detection function has been set to valid or invalid based on the flowchart illustrated in FIG. 4.

In step S2010, the CPU 111 determines whether a copy job to be executed is stored in the HDD 160. For example, if a copy setting was received by the operation unit 150, and the start key was pressed, the CPU 111 generates a copy job for executing copying based on the received setting, and stores the generated copy job in the HDD 160. Thus, the CPU 111 determines whether a generated copy job is stored in the HDD 160.

In step S2020, the CPU 111 issues an instruction to the scanner control unit 121, feeds the document set in the document feeding unit 122, and starts reading of the document. When a page of the document is read, image data representing an image of the read document page is generated, and the generated data is stored in the HDD 160.

In step S2030, the CPU 111 determines whether the double feed detection function is set to valid. Based on the processing illustrated in the flowchart of FIG. 4, information indicating whether the double feed detection function is set to valid or invalid is stored in the HDD 160. Consequently, the CPU 111 determines whether the double feed detection function is set to valid by referring to such information. If it is determined that the double feed detection function is set to invalid (NO in step S2030), the processing proceeds to step S2040. If it is determined that the double feed detection function is set to valid (YES in step S2030), the processing proceeds to step S2070.

In step S2070, the CPU 111 determines whether a double feed of the document has been detected based on a signal from the double feed detection sensor 123. If it is determined that a double feed of the document has been detected (YES in step S2070), the processing proceeds to step S2080. If it is determined that a double feed of the document has not been detected (NO in step S2070), the processing proceeds to step S2040.

In step S2040, the CPU 111 determines whether all of the pages of the document set in the document feeding unit 122 have been conveyed. If a signal indicating that there is a document page has been received from a document detection sensor provided in the document feeding unit, the CPU 111 determines that not all of the document pages set in the document feeding unit 122 have been conveyed (NO in step S2040). On the other hand, if a signal indicating that there are no document pages has been received from the document detection sensor provided in the document feeding unit, the CPU 111 determines that all of the document pages set in the document feeding unit 122 have been conveyed (YES in step S2040). If it is determined that not all of the document pages set in the document feeding unit 122 have been conveyed, the processing returns to step S2020 to perform reading of the next document page. If it is determined that all of the document pages set in the document feeding unit 122 have been conveyed, the processing proceeds to step S2050.

In step S2050, the CPU 111 transmits the image data stored in the HDD 160 and a printing instruction to the printer control unit 131, and prints an image on a sheet.

In step S2060, the CPU 111 repeats the processing of step S2050 until it is determined by the CPU 111 that printing has been completed. When it is determined by the CPU 111 that printing has been completed, the processing ends.

If the processing has proceeded from step S2070 to S2080, the CPU 111 issues an instruction to the scanner control unit 121 to stop the reading operation of the document. At this time, the document pages already conveyed by the scanner control unit 121 are discharged to the discharge tray 219. As a result, the user does not have to remove the document pages that were halted mid-course along the document conveyance path. The scanner control unit 121 does not feed the document that is to be fed next. Consequently, the reading operation of the document stops. Further, the CPU 111 may also stop conveyance of the document pages as soon as a double feed is detected. In this case, the user manually removes the document pages remaining in the conveyance path.

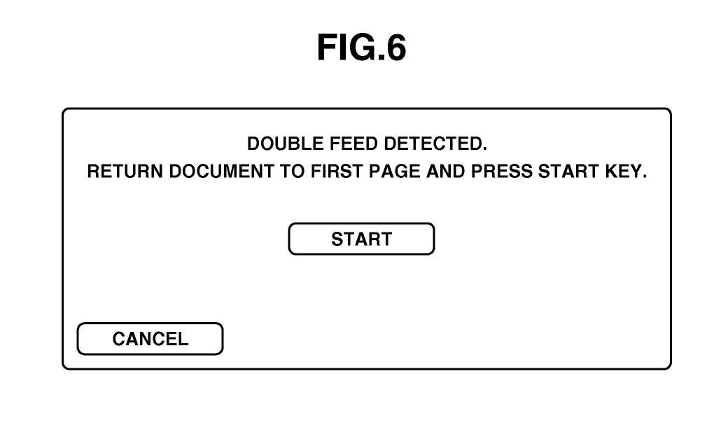

In step S2090, the CPU 111 displays a screen on the operation unit 150 indicating the fact that a double feed of the document has occurred. FIG. 6 illustrates an example of a screen that is displayed on the operation unit 150 in step S2060. The screen illustrated in FIG. 6 includes a notification message notifying the user that a double feed has been detected and a presentation message prompting the user to return to the first page of the document and to press a start key. Further, the screen illustrated in FIG. 6 includes the start key for performing document reading again, and a cancel key for cancelling the job.

In step S2100, the CPU 111 determines whether the start key has been pressed while the screen illustrated in FIG. 6 is displayed. If it is determined that the start key has been pressed (YES in step S2100), the processing proceeds to step S2120. If it is determined that the cancel key has been pressed (NO in step S2100), the processing proceeds to step S2110.

In step S2110, the CPU 111 cancels the copy job for which the reading operation of the document has stopped, and ends the processing. At this time, the CPU 111 deletes the copy job settings stored in the HDD 160 as well as the document image data that has already been read.

On the other hand, if the processing proceeded from step S2100 to S2120, the CPU 111 deletes the document image data that has already been read, without deleting the copy job settings stored in the HDD 160. Then, the processing returns to step S2020 in order to re-read the document from the first page based on the copy job settings.

Thus, the user can set the double feed detection function to invalid so that document reading does not mistakenly stops when reading a document like an envelope or a document on which a photograph or a label has been pasted. Consequently, when reading a document like an envelope, the user does not need to wait in front of the MFP 100 until document reading has been completed just in case document reading stops.

On the other hand, when conveying a plain paper document, the user can set the double feed detection function to valid. Consequently, document reading stops if two or more sheets of plain paper are conveyed overlapping, so that the user can restart the job by resetting the document in the ADF at that point.

Further, although in the present exemplary embodiment a copy job has been described as an example, the present invention is not limited to this. For example, as long as the operation involves document reading, the same processing can also be applied in the above-mentioned scan and store job, scan and send job, and facsimile transmission job. If applying in the scan and store job, the processing may end without executing step S2050 and S2060. If applying in the scan and send job or the facsimile transmission job, in step S2050, the CPU 111 can transmit the read image, and in step S2060, the CPU 111 can determine whether transmission has been completed.

Further, although in the present exemplary embodiment an example has been described in which printing starts after reading of all the document pages has been completed, printing can also be performed in parallel with reading of the document. In that case, printing can start based on completion of preparation of the image data to be printed on the first sheet.

In addition, although in the present exemplary embodiment an example in which setting of the double feed detection function to valid or invalid has been described as a MFP 100 device setting, the present invention is not limited to this. For example, the setting of the double feed detection function to valid or invalid may be set as a job setting for each job. In that case, whether to set the double feed detection function to valid or invalid is determined during the period that that job is being executed, and when that job is completed, the setting may be returned to the MFP 100 device setting.

In the first exemplary embodiment, an example in which the double feed detection function is set to valid or invalid has been described.

In a second exemplary embodiment, an example is described in which the double feed detection function is set to valid or invalid based on the type of sheet to be used in printing of an image.

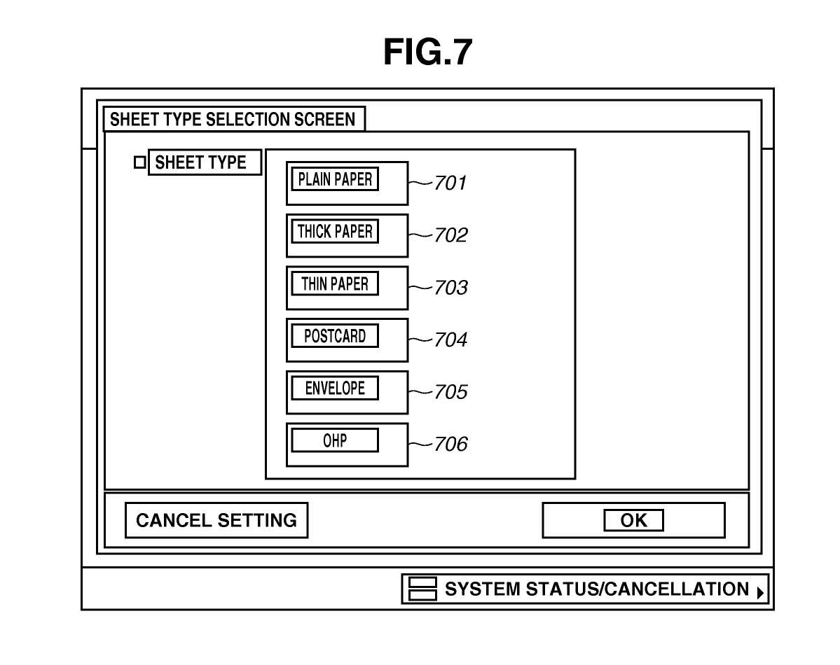

For example, if the sheet to be used in printing of an image is an envelope, there is a high likelihood that a document to be read in the reader unit 120 is also an envelope. The reason for this is because when producing envelopes, a user will often write an address on one envelope, and copy the envelope having that address onto a plurality of envelopes which should have the same address. It is rare for a user to write an address onto a sheet other than an envelope and to copy that onto other envelopes. When copying an image onto an envelope, the user first sets the envelope in the manual feeding tray 340 to display a screen illustrated in FIG. 7 on the operation unit 150. The screen illustrated in FIG. 7 is a screen for setting the type of sheet to be used in printing. Buttons 701 to 706 are for specifying the type of sheet to be used in printing. For example, a button 701 is for specifying plain paper as the type of sheet, and a button 705 is for specifying an envelope as the type of sheet. The user selects an envelope as the type of sheet to be used in printing by pressing the button 705. If an envelope is selected by the user, of the image of the document read by the document feeding unit 122, the MFP 100 reads an image for an area corresponding to the selected envelope size, and prints the read image on the envelope.

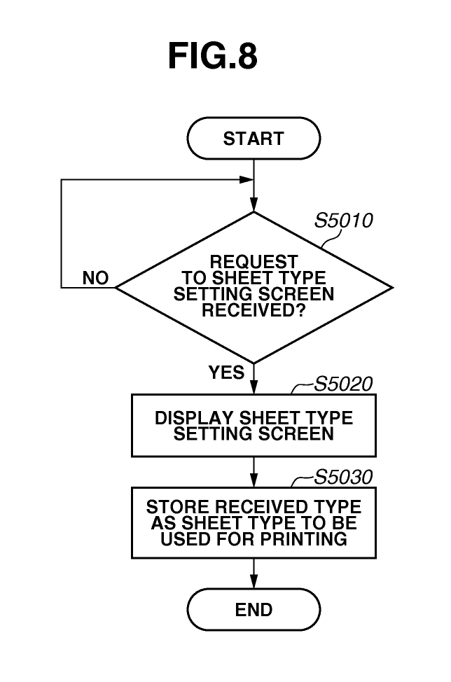

The control for setting the type of sheet to be used in printing will now be described with reference to a flowchart illustrated in FIG. 8. Processing illustrated in the flowchart of FIG. 8 is performed by the CPU 111 reading and executing in the RAM 114 a program stored in the ROM 115. Further, the processing illustrated in this flowchart is set as a job setting before execution of the job.

In step S5010, the CPU 111 determines whether a request to display a screen for setting the type of sheet has been received via the operation unit 150. If it is determined that a display request has been received (YES in step S5010), the processing proceeds to step S5020.

In step S5020, the CPU 111 displays the sheet type setting screen illustrated in FIG. 7 on the operation unit 150.

In step S5030, the CPU 111 stores the type that was received by the screen illustrated in FIG. 7 in the HDD 160 as the type of sheet to be used in printing, and ends the processing.

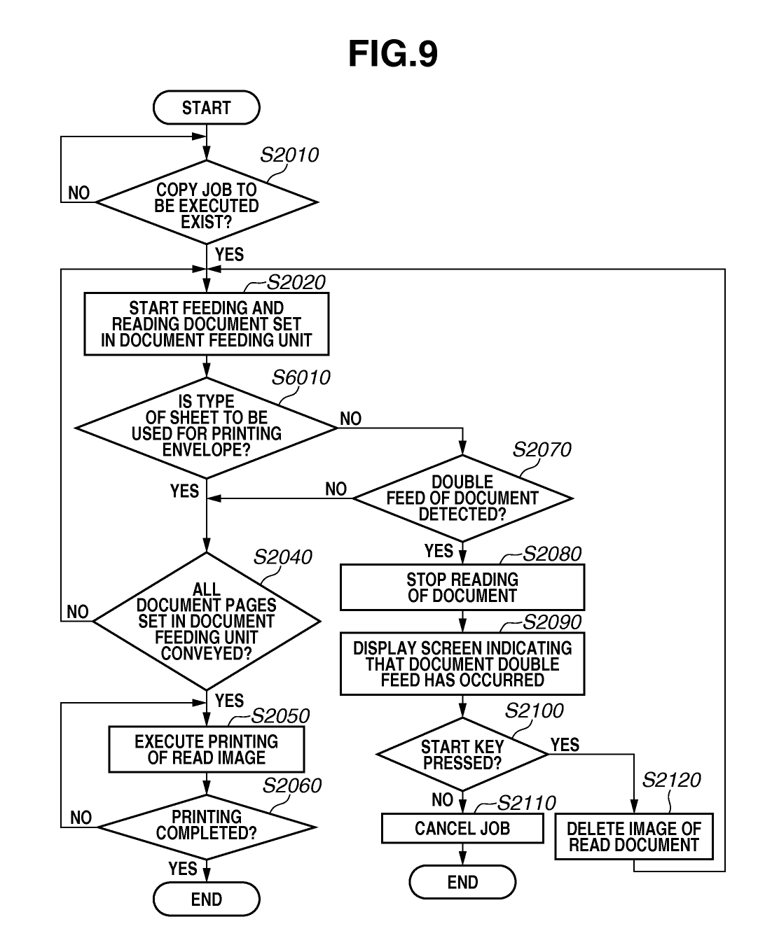

The control for setting the type of sheet to be used in printing will now be described with reference to a flowchart illustrated in FIG. 9. Processing illustrated in the flowchart of FIG. 9 is performed by the CPU 111 reading and executing in the RAM 114 a program stored in the ROM 115. Further, the processing illustrated in this flowchart is executed after the processing illustrated in the flowchart of FIG. 8 has been performed.

Just the difference with FIG. 5 will be described. The difference with FIG. 5 is that step S6010 is executed instead of step S2030 of FIG. 5.

In step S2020, the CPU 111 issues an instruction to the scanner control unit 121, feeds the document set in the document feeding unit 122, and starts reading of the document. When a page of the document is read, image data representing an image of the read document page is generated, and the generated data is stored in the HDD 160.

In step S6010, the CPU 111 determines whether the type of sheet to be used in printing is an envelope. Based on the processing illustrated in the flowchart of FIG. 8, the determination is made regarding whether the type of sheet stored in the HDD 160 is an envelope. If it is determined that an envelope is set (YES in step S6010), the processing proceeds to step S2040. If it is determined that an envelope is not set (NO in step S6010), the processing proceeds to step S2070. For example, if plain paper, thick paper, thin paper, postcard, OHP or the like is set, the processing proceeds to step S2070.

The processing from step S2070 onwards repeats the same processing as illustrated in FIG. 5.

Thus, if the type of sheet required for printing is an envelope, the double feed detection function is set to invalid, and if the type of sheet required for printing is plain paper, the double feed detection function is set to valid. Consequently, when copying an image on an envelope, or, in other words, when there is a high likelihood that a document is an envelope, the double feed detection function can be set to invalid so as to avoid reading mistakenly being stopped by the double feed detection function. Therefore, when reading a document like an envelope, the user does not need to wait in front of the MFP 100 until document reading has been completed just in case document reading stops.

On the other hand, when printing an image on plain paper, by setting the double feed detection function to valid, document reading stops if two or more sheets of plain paper are conveyed overlapping, so that the user can be made to restart a job by resetting a document in the ADF at that point.

By selecting the type of sheet required for printing, whether the double feed detection function is set to valid or invalid is automatically determined. Therefore, the user does not need to determine whether to set the double feed detection function to valid or invalid.

Further, although in the present exemplary embodiment an example has been described in which printing starts after reading of all the document pages has been completed, printing can also be performed in parallel with reading of the document. In that case, printing can start based on completion of preparation of image data to be printed on the first sheet.

In the above-described exemplary embodiments, examples have been described in which, when a double feed is detected, document reading or document conveyance stops. The present invention is, however, not limited to this. For example, when a double feed is detected, reading may be performed until the last page of a document, a user may be notified of the fact that a double feed occurred, and the user may be made to read the document again. In that case, the user resets the document in the reader unit 120, and issues an instruction to start reading of the document via the operation unit 150. Further, when the instruction to start reading has been received, the CPU 111 makes the reader unit 120 read the document, and the read document pages are stored in the HDD 160 instead of the pages for which a double feed occurred.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-248037 filed Nov. 29, 2013, which is hereby incorporated by reference herein in its entirety.

What is claimed is:

1. A document reading apparatus comprising:
a conveyance unit configured to convey a document;
a detection unit configured to detect a double feed of the document conveyed by the conveyance unit;
a reading unit configured to read an image of the document conveyed by the conveyance unit;
a setting unit configured to set whether to stop a reading operation of the document as a setting of the document reading apparatus based on detection of a double feed of the document by the detection unit; and
a control unit configured to, if the reading operation of the document has been set by the setting unit to stop based on detection of a double feed of the document by the detection unit, control so as to stop the reading operation of the document based on detection of a double feed of the document by the detection unit, and if the reading operation of the document has been set by the setting unit not to stop based on detection of a double feed of the document by the detection unit, control so as to continue without stopping the reading operation of the document based on detection of a double feed of the document by the detection unit.

2. The document reading apparatus according to claim 1, further comprising:
a display unit configured to display a screen for setting whether to stop the reading operation of the document based on detection of a double feed of the document by the detection unit,
wherein the setting unit is configured to, if an instruction to stop the reading operation of the document based on detection of a double feed of the document by the detection unit has been received via the screen, stop the reading operation of the document based on detection of a double feed of the document by the detection unit, and if an instruction not to stop the reading operation of the document based on detection of a double feed of the document by the detection unit has been received via the screen, not stop the reading operation of the document based on detection of a double feed of the document by the detection unit.

3. The document reading apparatus according to claim 1, further comprising:
a first printing unit configured to print an image of the document on a sheet; and
a receiving unit configured to receive a type of the sheet,
wherein the setting unit is configured to, if the type of the sheet received by the receiving unit is a first type, set so as to stop the reading operation of the document based on detection of a double feed of the document by the detection unit, and
wherein the setting unit is configured to, if the type of the sheet received by the receiving unit is a second type that is different from the first type, set so as not to stop the reading operation of the document based on detection of a double feed of the document by the detection unit.

4. The document reading apparatus according to claim 3, wherein the second type includes an envelope.

5. The document reading apparatus according to claim 3, wherein the first type includes plain paper.

6. The document reading apparatus according to claim 1, further comprising a notification unit configured to notify a user of occurrence of a double feed of the document if the reading operation of the document has stopped based on detection of a double feed of the document by the detection unit.

7. The document reading apparatus according to claim 1, further comprising a presentation unit configured to prompt a user to set so that a document is re-conveyed by the conveyance unit if the reading operation of the document has stopped based on detection of a double feed of the document by the detection unit.

8. The document reading apparatus according to claim 1, further comprising a second printing unit configured to print an image read by the reading unit.

9. A document reading apparatus comprising:
a conveyance unit configured to convey a document;
a detection unit configured to detect a double feed of the document conveyed by the conveyance unit;
a reading unit configured to read an image of the document conveyed by the conveyance unit;
a setting unit configured to set whether to detect a double feed of the document with the detection unit; and
a control unit configured to, if detection of a double feed of the document with the detection unit has been set by the setting unit, control so as to detect a double feed of the document with the detection unit, and if detection of a double feed of the document with the detection unit has not been set by the setting unit, control so as not to detect a double feed of the document with the detection unit.

10. A method for controlling a document reading apparatus, the method comprising:
detecting a double feed of a document conveyed by a conveyance unit configured to convey a document;
reading an image of the document conveyed by the conveyance unit;
setting whether to stop a reading operation of the document as a setting of the document reading apparatus based on detection of a double feed of the document;
controlling so that, if the reading operation of the document has been set to stop based on detection of a double feed of the document, the reading operation of the document stops based on detection of a double feed of the document; and
controlling so that, if the reading operation of the document has been set not to stop based on detection of a double feed of the document, the reading operation of the document continues without stopping based on detection of a double feed of the document.

11. A computer-readable storage medium storing a program that makes a computer execute a method for controlling a document reading apparatus, the method comprising:
detecting a double feed of a document conveyed by a conveyance unit configured to convey a document;
reading an image of the document conveyed by the conveyance unit;
setting whether to stop a reading operation of the document as a setting of the document reading apparatus based on detection of a double feed of the document;
controlling so that, if the reading operation of the document has been set to stop based on detection of a double feed of the document, the reading operation of the document stops based on detection of a double feed of the document; and
controlling so that, if the reading operation of the document has been set not to stop based on detection of a double feed of the document, the reading operation of the document continues without stopping based on detection of a double feed of the document.
